(19) United States
(12) Patent Application Publication
(10) Pub. No.: US 2026/0003582 A1
(43) Pub. Date: Jan. 1, 2026

(54) Hybrid Coding System

(71) Applicant: Open Text Corporation, Waterloo (CA)

(72) Inventors: Gino Vicari, Meerbeek (BE); Dong Chen, Waterloo (CA); Ian James Whitfield, Bridgend (GB)

(21) Appl. No.: 18/760,453

(22) Filed: Jul. 1, 2024

(51) Int. Cl. G06F 8/35

(52) U.S. Cl. CPC G06F 8/35

(57) ABSTRACT

Systems and methods for hybrid coding are provided. Various embodiments of the present technology provide systems and methods that are designed to simplify software development by combining a code snippet database, a chatbot interface, and a large language model (LLM). In some embodiments, a chatbot interface is provided where users describe their requirements, preferences, and project details via a conversation with the chatbot. Using the LLM, the system searches the code snippet database to select relevant code snippets tailored to the user's needs. The selected code snippet is returned to the user, along with any desired supporting documentation or information.

### TECHNICAL FIELD

This disclosure relates generally to software development. In particular, this disclosure relates to systems and methods for generating code snippets using the combination of an artificial intelligence (AI) based assistant service and a large language model (LLM) to generate code snippets from a database of code snippets based on user prompts.

### BACKGROUND

Drafting software code often encounters challenges, particularly when attempting to reuse existing code. One problem relates to understanding the intricacies and dependencies of the code being reused. Without a comprehensive grasp of how the existing code operates, integrating it into a new project can lead to unforeseen bugs or conflicts. Additionally, ensuring compatibility between the code and a project's requirements can be complex. Consequently, while reusing existing code can expedite development, it demands meticulous attention to detail and thorough testing to mitigate potential pitfalls.

One approach in the art for streamlining code generation relates to utilizing LLMs to generate code, which, in theory, can expedite the development process by generating entire functions based on provided specifications. However, challenges arise in ensuring the generated code is efficient, secure, and adheres to best practices. LLMs typically lack a deep understanding of programming nuances and domain-specific requirements, leading to suboptimal solutions or even introducing vulnerabilities. Thus, while LLMs offer potential for code generation, their outputs typically fall short in terms of quality and reliability of the resulting code.

### SUMMARY

Systems and methods for hybrid coding are described that, in some embodiments, include storing and indexing a plurality of code snippets in a repository, providing a chatbot interface for a user to communicate with a chat agent regarding desired code information, collecting conversation data from communications between the user and the chat agent to an LLM, selecting, by the LLM based on the conversation data, one of the plurality of code snippets stored in the repository, and presenting the selected code snippet to the user.

Embodiments of the present invention also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram depicting one example of an architecture that may be used to implement the disclosed hybrid coding system.

FIG. 2 is a block diagram depicting another example of an architecture that may be used to implement the disclosed hybrid coding system.

FIG. 3 is a flowchart depicting a hybrid coding process.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The present disclosure describes a system and method that is designed to simplify software development by combining a code snippet database(s), a chatbot interface, and an LLM. In some embodiments, an extensive database of code snippets, covering various programming languages and functionalities is generated and indexed. The system includes a chatbot interface where developers describe their requirements, preferences, and project details via a conversation with the chatbot. Through natural language processing, the system refines user inputs, ensuring clear specifications. Using an advanced LLM, the system searches the code snippet database to find relevant solutions tailored to the user's needs. This approach enhances efficiency and innovation in software development workflows.

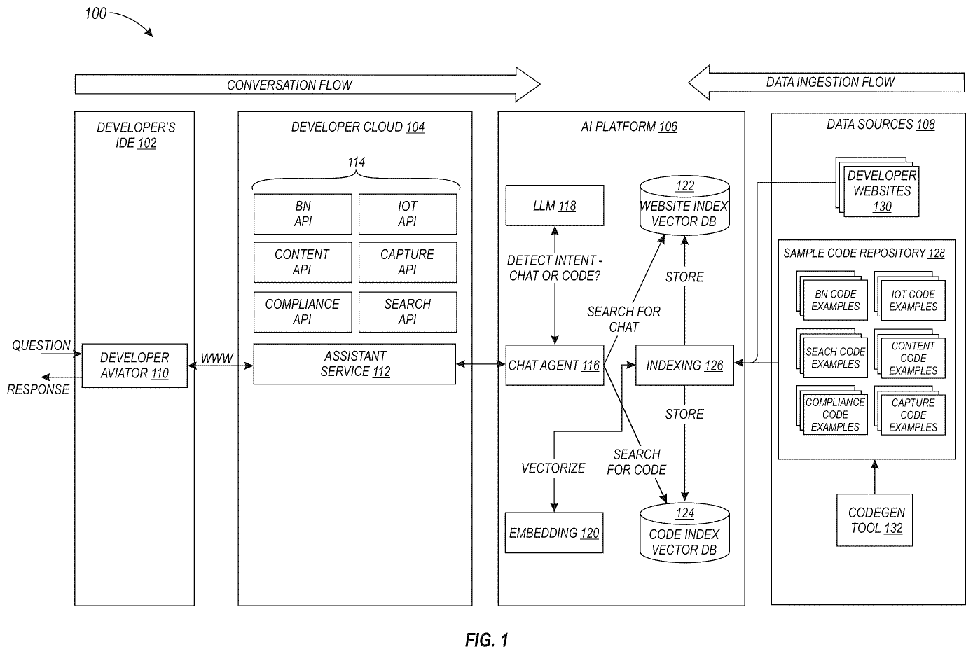

FIG. 1 is a block diagram showing one example of an architecture 100 that may be used to implement the disclosed hybrid coding system. The hybrid coding system will be described in the contexts shown in the architectural diagrams, although the hybrid coding system can be implemented in any desired environment, as one skilled in the art would understand. The architecture 100 shown in FIG. 1 includes a developer's integrated development environment (IDE) 102, a developer cloud 104, and AI platform 106, and data sources 108, each of which are described in detail below. Generally, a conversation flows from the IDE 102 to the AI platform 106 via the developer cloud 104, as shown by the arrow. Data ingestion generally flows from the data sources 108 to the AI platform 106, as shown by the arrow.

The IDE 102 is a software application that provides comprehensive facilities to computer programmers for software development. In a typical IDE, the IDE encompasses a range of tools such as code editors, debuggers, compilers, and graphical designers, all integrated into a single user interface to streamline the software development process. The IDS can act as a central hub where developers write, edit, compile, debug, and manage their code projects. In some embodiments, the IDE 102 can be comprised of Visual Studio Code (VS Code), an open-source code editor developed by Microsoft. VS Code is designed for a wide range of development tasks and supports various programming languages and frameworks. Other IDEs may also be used, as one skilled in the art would understand. The IDE 102 enables extensibility, allowing users to find and install extensions to add language support, debuggers, tools for cloud services, etc. The IDE 102 also provides an intuitive user interface for a user.

Developer cloud 104 is a cloud development platform providing a cloud computing service designed to support software development processes. Developer cloud 104 provides developers with the tools, infrastructure, and services to build, test, deploy, and manage applications in the cloud. The developer cloud 104 may include a range of services and features, such as enabling developers to compute resources, store data, connect to networks, use development tools, test and debug, etc. In some embodiments, the developer cloud 104 can be provided using services designed by OpenText to access OpenText APIs and SDKs to integrate OpenText functionality into a developer's programs. This enables developers to extend the capabilities of OpenText products or to build custom solutions that leverage OpenText technology. Other developer cloud platforms may also be used (e.g., platforms provided by AWS, Azure, Google Cloud, etc.), as one skilled in the art would understand.

AI platform 106 is machine learning (ML) platform that allows developers to build, deploy, and scale ML models. AI platform 106 may integrate data engineering, data science, and ML engineering workflows into a unified environment, facilitating collaboration and efficiency in ML projects. AI platform 106 may provide various features to developers, such as model training and development for training and deploying models. In some embodiments, AI platform 106 can be comprised of Google Vertex AI, a ML platform developed by Google Cloud. Other AI platforms may also be used, as one skilled in the art would understand.

Data sources 108 provides data to the hybrid coding system, as described in detail below. In the example of FIG. 1, data sources include developer websites 130, as well as sample code repository 128. The sample code repository 128 can store any desired code examples (snippets), such as the examples listed in FIG. 1 (e.g., BN code examples, IoT code examples, search code examples, content code examples, compliance code examples, capture code examples, etc.).

As mentioned above, the disclosed hybrid coding system simplifies software development by enabling a developer to locate code snippets from a code snippet database via a chatbot interface. In some embodiments, a user can provide prompts to a chatbot interface in a conversational manner, and in response, the hybrid coding system is able to present the user with suggestions of code snippets and related information. By using prompts, the system enhances productivity and efficiency by allowing users to interact with the system in a more intuitive and conversational manner, leveraging the power of generative AI to streamline workflows and decision-making processes. As an example, a user may provide a question to the chatbot interface such as “Can you provide me information on content metadata services?” In response, the hybrid coding system may return information on a particular Content Media Services, along with a help link, for example. The user may continue the conversion with the chatbot, requesting more information for providing follow-up questions. For example, the user may follow up with “Can you provide a JavaScript code for doing this?” In response, the hybrid coding system returns sample code from the code snippet database. In another example, the user may follow up with “What about this particular function call in the returned code snippet?” In response the hybrid coding system may return more information relating to that function call, and/or with another code snippet. More complex requests and replies are also possible, for example, a user may ask in a follow-up question, “Can you provide me with the code sample to get all of the types definitions in JavaScript ECMA?” The chatbot can reply with a working code snippet meeting the user's request. Note that the code snippet is not generated in response to the request, but already exists in the repository 128. Also note that, along with the requested code snippet, the hybrid coding system may provide the user with instructions on how to use the snippet, test the snippet, etc., for example. In another example, a user may ask “Is there a way to get the access token through JavaScript?” A reply to the user may include a code snippet for that purpose, along with documentation.

In some embodiments, a chatbot interface is provided by developer aviator 110 of the IDE 102. One example of a developer aviator 110 is OpenText Developer Aviator, developed by OpenText. The developer aviator 110 may provide a suite of AI-driven tools designed to enhance various aspects of business operations through the use of generative AI and LLMs. The developer aviator 110 integrates conversational search within the system, making information retrieval more efficient and user-friendly.

The developer aviator 110 communicates with the assistant service 112 of the developer cloud 104 over the internet, in some examples. The assistant service 112 could be thought of as the back end of the chatbot. Generally, the assistant service 112 is a software application designed to assist users by performing tasks, answering questions, and providing information through natural language interactions. The assistant service 112 may leverage AI, ML, and natural language processing (NLP) to understand and respond to user requests effectively. The developer cloud 104 also provides various application programming interfaces (API) 114. In the example of FIG. 1, the APIs include APIs of various types and categories such as BN APIs, IoT APIs, content APIs, capture APIs, compliance APIs, search APIs, etc.

As shown in FIG. 1, the assistant service 112 communicates with the chat agent 116 of the AI platform 106. The chat agent 116 also communicates with LLM 118, which detects the intent of the conversation with the user (e.g., whether the conversation is about code, or something else). For example, the LLM 118 may detect from the conversation that user is inquiring about software code or a chat (i.e., requesting information, perhaps from a developer's website). If the detected intent was “chat,” the chat agent 116 may initiate a search of a website index vector database (DB) 122 for information relating to the conversation of the user. In some embodiments, the DB 122 stores objects from developer websites 130, which have been indexed by indexing module 126. As an example, if a user asked the chatbot “Can you tell me which developer APIs does the platform offer?”, an answer can be generated based on the information from the developer's website, which has been stored and indexed in the DB 122. If the detected intent was “code,” the chat agent 116 may initiate a search of a code index vector DB 124 for software code snippets relating to the conversation of the user or specific requests by the user. In some embodiments, the DB 124 stores objects from the sample code repository 128, which have been indexed by indexing module 126. As mentioned above, the LLM 118 is used to search the sample code snippets. The LLM can use the entire user conversation, including follow-up questions to perform a comprehensive search of the stored code snippets. Similarly, the sample code snippets from the repository 128 are vectorized by embedding module 120 based on the description of the code.

The data ingestion for the hybrid coding system was discussed briefly above. With respect to the website index vector DB 122, in some embodiments, developer websites 130 are crawled and indexed by indexing module 126. In addition, this data is vectorized. In general vectorizing the data stored in the database relates to transforming the data into numerical vectors that can be used for various types of analyses, especially those involving ML and AI. Vectorization is especially useful for handling unstructured data, enabling this type of data to be searched, compared, and analyzed efficiently, as one skilled in the art would understand. The vector databases (e.g., DB 122. DB 124) may use various techniques to index the vectorized data to allow for efficient searches. In some examples, queries can be vectorized, and the DB will retrieve vectors closest to the query vector.

The codegen tool 132 is a tool that can be used to generate and prepare code samples for the code sample repository 228. For example, the codegen tool 132 can take API specifications, or similar documentation, and generate code snippets for the sample code repository 228. The codegen tool 132 also generates metadata for each code sample. The metadata can be loaded into the vector DB to provide more context to help improve the quality of searches. In some embodiments, another LLM can be developed that understands code, and can read a piece of code, and from its understanding of the code, generate a description and summary of the code.

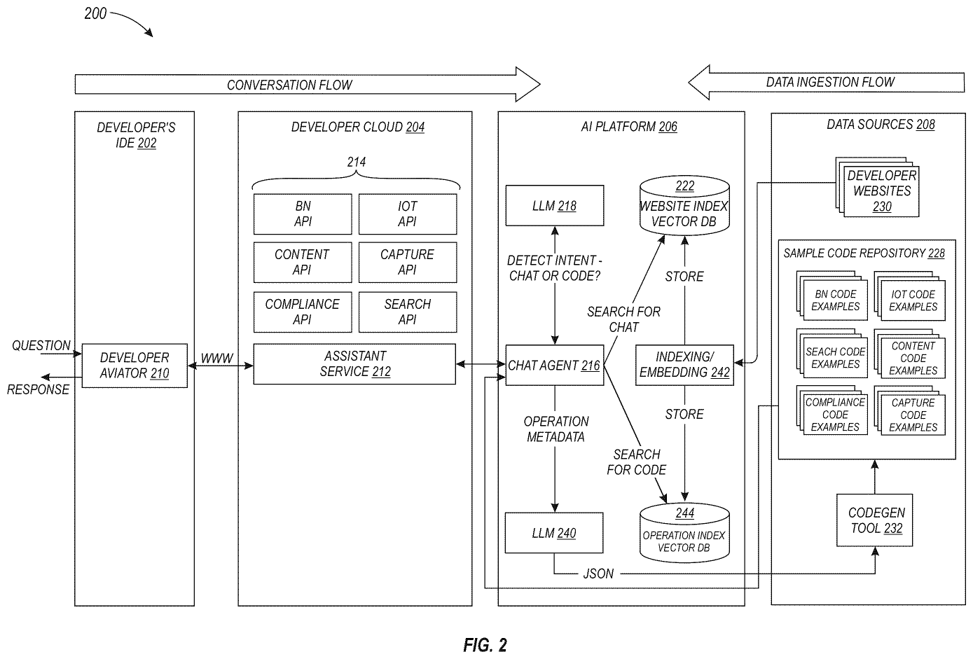

FIG. 2 is a block diagram showing another example of an architecture 200 that may be used to implement the disclosed hybrid coding system. The architecture 200 shown in FIG. 2 is generally the same as the architecture 100 shown in FIG. 1, with differences primarily in the AI platform 206 and data sources 208. As before, the hybrid coding system will be described in the contexts shown in the architectural diagrams, although the hybrid coding system can be implemented in any desired environment, as one skilled in the art would understand. The architecture 200 shown in FIG. 1 includes an IDE 202, a developer cloud 204, and AI platform 206, and data sources 208. Generally, as with FIG. 1, a conversation flows from the IDE 202 to the AI platform 206 via the developer cloud 204, as shown by the arrow. Data ingestion generally flows from the data sources 208 to the AI platform 206, as shown by the arrow.

Similar to that shown in FIG. 1, a chatbot interface is provided by developer aviator 210 of the IDE 202. The developer aviator 210 communicates with the assistant service 212 of the developer cloud 204 over the internet, in some examples. The developer cloud 204 also provides various application programming interfaces (API) 214. As shown in FIG. 2, the assistant service 212 communicates with the chat agent 216 of the AI platform 206. The chat agent 216 also communicates with LLM 218, which detects the intent of the conversation with the user. If the detected intent was “chat,” the chat agent 216 may initiate a search of a website index vector database (DB) 222 for information relating to the conversation of the user. In some embodiments, the DB 222 stores objects from developer websites 230, which has been indexed by indexing/embedding module 242. If the detected intent was “code,” the chat agent 216 may initiate a search of an operational index vector DB 244 for software code snippets relating to the conversation of the user or specific requests by the user. In some embodiments, the DB 224 stores objects from the sample code repository 228, which have been indexed by indexing module 226. As mentioned above, the LLM is used to search the sample code snippets. The LLM can use the entire user conversation, including follow-up questions to perform a comprehensive search of the stored code snippets.

The architecture 200 shown in FIG. 2 can help with the code sample generation. In this example instead of generating a large set of code samples, a smaller set of operation data can be indexed in the operation index vector DB 244. Note that “operation data” is intended to relate to an end point or a method for a given API spec. When a question for code is received by the chat agent 216, the system will search the operation index vector DB 244 to retrieve a matched operation. The matched operation is used as a context, and is provided (along with its metadata) to the LLM 240, which will generate a configuration file (e.g., in JavaScript Object Notation (JSON) format) or configuration data. The configuration file is passed to the codegen tool 232 to dynamically generate the matched code sample for that question. The matched code is then provided to the user via the chat agent 216, as illustrated by the arrow from the repository 228 to the chat agent 216. Using the architecture of FIG. 2, it is not required to pre-generate a full set of code samples. In some embodiments, the generated code can be stored and indexed for future use (for example, the process described with respect to FIG. 1). In other embodiments, the code can be dynamically generated for each request.

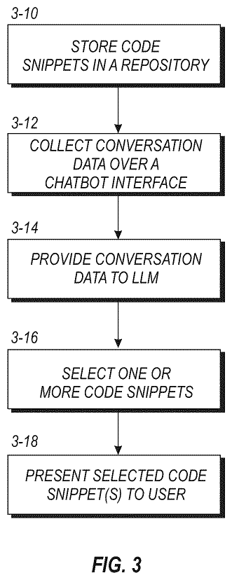

FIG. 3 is a flowchart illustrating one example of the operation of a hybrid coding system, such as that illustrated in FIG. 1. At step 3-10, a plurality of code snippets and associated meta data are stored and indexed in a repository (e.g., repository 128/228). The code snippets can be created or generated ahead of time, or as in the example of FIG. 2, can be generated dynamically. A chatbot interface (e.g., developer aviator 110/210) is provided for a user to communicate with a chat agent regarding desired code information. A conversation between a user and the chatbot may include an initial question, follow questions, etc., as one skilled in the art would understand. During the conversation, the system collects conversation data from communications between the user and the chat agent (step 3-12). At step 3-14, the conversation data is provided to a LLM (e.g., LLM 118/218). The LLM analyzes the conversation data and selects (at step 3-16) one of the plurality of code snippets stored in the repository. At step 3-18, the selected code snippet is presented to the user. The user may also be provided with supporting documentation, specifications, links, etc., as desired.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method of hybrid coding, comprising:
storing and indexing a plurality of code snippets in a repository, each of the code snippets including metadata associated a respective code snippet;
providing a chatbot interface for a user to communicate with a chat agent regarding desired code information;
collecting conversation data from communications between the user and the chat agent to a large language model (LLM);
selecting, by the LLM based on the conversation data, one of the plurality of code snippets stored in the repository; and
presenting the selected code snippet to the user.

2. The method of claim 1, wherein the conversation data includes a reference to a desired type of software service.

3. The method of claim 1, wherein the conversation data includes a reference to a desired computer language.

4. The method of claim 1, further comprising detecting, by the chat agent, whether the conversation data relates to code or to a chat.

5. The method of claim 4, further comprising searching a code index database when the chat agent determines that the conversation data relates to code.

6. The method of claim 4, further comprising searching a website index database when the chat agent determines that the conversation data relates to a chat.

7. The method of claim 1, further comprising, responsive to receiving a prompt from a user, generating and presenting to the user, over the chatbot interface, a follow up question requesting more information relating to the prompt.

8. A system for hybrid coding, the system comprising:
a processor; and
a non-transitory computer readable medium storing instructions translatable by the processor, the instructions when translated by the processor perform:
storing and indexing a plurality of code snippets in a repository, each of the code snippets including metadata associated a respective code snippet;
providing a chatbot interface for a user to communicate with a chat agent regarding desired code information;
collecting conversation data from communications between the user and the chat agent to a large language model (LLM);
selecting, by the LLM based on the conversation data, one of the plurality of code snippets stored in the repository; and
presenting the selected code snippet to the user.

9. The system of claim 8, wherein the conversation data includes a reference to a desired type of software service.

10. The system of claim 8, wherein the conversation data includes a reference to a desired computer language.

11. The system of claim 8, further comprising detecting, by the chat agent, whether the conversation data relates to code or to a chat.

12. The system of claim 11, further comprising searching a code index database when the chat agent determines that the conversation data relates to code.

13. The system of claim 11, further comprising searching a website index database when the chat agent determines that the conversation data relates to a chat.

14. The system of claim 8, further comprising, responsive to receiving a prompt from a user, generating and presenting to the user, over the chatbot interface, a follow up question requesting more information relating to the prompt.

15. A computer program product comprising a non-transitory computer readable medium storing instructions translatable by a processor, the instructions when translated by the processor perform, in an enterprise computing network environment:
storing and indexing a plurality of code snippets in a repository, each of the code snippets including metadata associated a respective code snippet;
providing a chatbot interface for a user to communicate with a chat agent regarding desired code information;
collecting conversation data from communications between the user and the chat agent to a large language model (LLM);
selecting, by the LLM based on the conversation data, one of the plurality of code snippets stored in the repository; and
presenting the selected code snippet to the user.

16. The computer program product of claim 15, wherein the conversation data includes a reference to a desired type of software service.

17. The computer program product of claim 15, further comprising detecting, by the chat agent, whether the conversation data relates to code or to a chat.

18. The computer program product of claim 17, further comprising searching a code index database when the chat agent determines that the conversation data relates to code.

19. The computer program product of claim 17, further comprising searching a website index database when the chat agent determines that the conversation data relates to a chat.

20. The computer program product of claim 15, further comprising, responsive to receiving a prompt from a user, generating and presenting to the user, over the chatbot interface, a follow up question requesting more information relating to the prompt.
